(19) United States
(12) Patent Application Publication
(10) Pub. No.: US 2025/0254357 A1
(43) Pub. Date: Aug. 7, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/177,458

(22) Filed: Apr. 11, 2025

Related U.S. Application Data
(63) Continuation of application No. PCT/CN2023/124119, filed on Oct. 11, 2023.

(30) Foreign Application Priority Data
Oct. 13, 2022 (WO) PCT/CN2022/125128

(51) Int. Cl. H04N 19/593; H04N 19/105; H04N 19/11; H04N 19/132; H04N 19/176; H04N 19/196

(52) U.S. Cl. CPC H04N 19/593; H04N 19/105; H04N 19/11; H04N 19/132; H04N 19/176; H04N 19/197

(57) ABSTRACT

Embodiments of the present disclosure provide a solution for video processing. A method for video processing is proposed. The method comprises: deriving, for a conversion between a video unit of a video and a bitstream of the video, a prediction sample of the video unit; deriving a refined prediction sample of the video unit by applying a refinement process to the prediction sample; and performing the conversion based on the refined prediction sample.

### CROSS REFERENCE

This application is a continuation of International Application No. PCT/CN2023/124119, filed on Oct. 11, 2023, which claims the benefit of International Application No. PCT/CN2022/125128, filed on Oct. 13, 2022. The entire contents of these applications are hereby incorporated by reference in their entireties.

### FIELDS

Embodiments of the present disclosure relates generally to video processing techniques, and more particularly, to intra block copy (IBC) with local illumination compensation (LIC).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: deriving, for a conversion between a video unit of a video and a bitstream of the video, a prediction sample of the video unit; deriving a refined prediction sample of the video unit by applying a refinement process to the prediction sample; and performing the conversion based on the refined prediction sample. In this way, it can improve coding efficiency of IBC.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: deriving a prediction sample of a video unit of the video; deriving a refined prediction sample of the video unit by applying a refinement process to the prediction sample; and generating the bitstream based on the refined prediction sample.

In a fifth aspect, a method for storing a bitstream of a video is proposed. The method comprises: deriving a prediction sample of a video unit of the video; deriving a refined prediction sample of the video unit by applying a refinement process to the prediction sample; generating the bitstream based on the refined prediction sample; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of encoder block diagram of VVC;

FIG. 5 illustrates several intra prediction modes;

FIG. 6A and FIG. 6B illustrate reference samples for wide-angular intra prediction;

FIG. 7 illustrates problem of discontinuity in case of directions beyond 45°;

FIG. 8 illustrates example of motion vector scaling for temporal merge candidate;

FIG. 9A and FIG. 9B illustrate MMVD search point;

FIG. 10 illustrates an example of local illustration compensation;

FIG. 11 illustrates no subsampling for the short side;

FIG. 12 illustrates IBC reference region depending on current CU position;

FIG. 13 illustrates examples of symmetry in screen content pictures;

FIG. 14A illustrates an illustration of BV adjustment for horizontal flip;

FIG. 14B illustrates an illustration of BV adjustment for vertical flip;

FIG. 15 illustrates an intra template matching search area used;

FIG. 16 illustrates templates used to derive the parameters of LIC for IBC;

FIG. 17 illustrates a flowchart of a method for video processing in accordance with embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

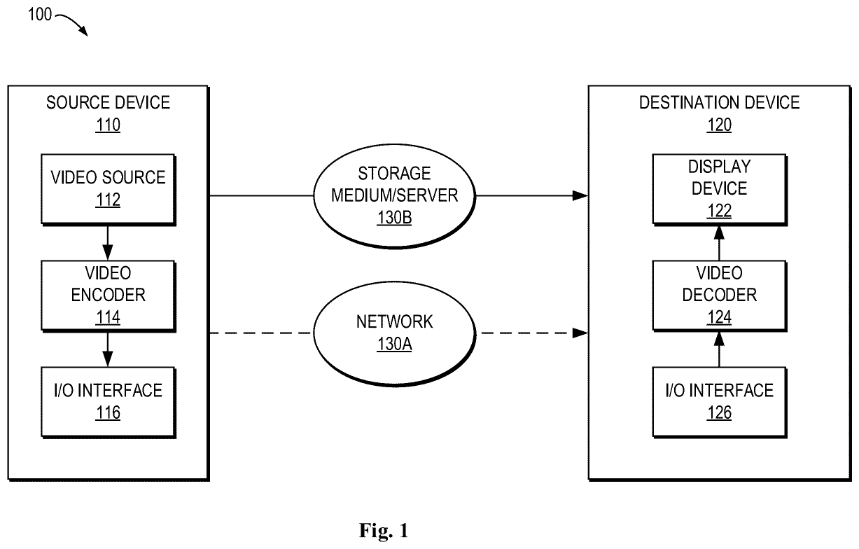

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

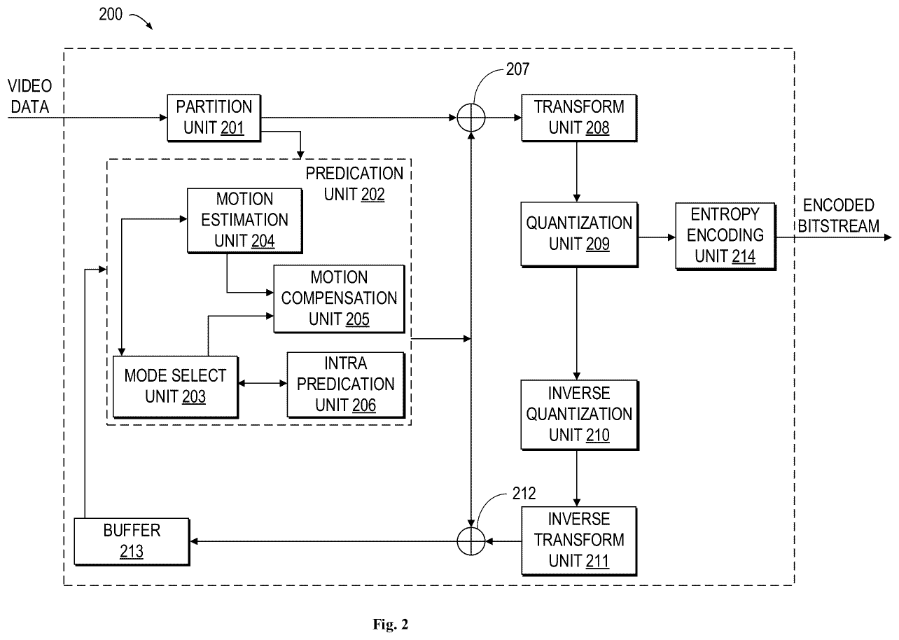

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

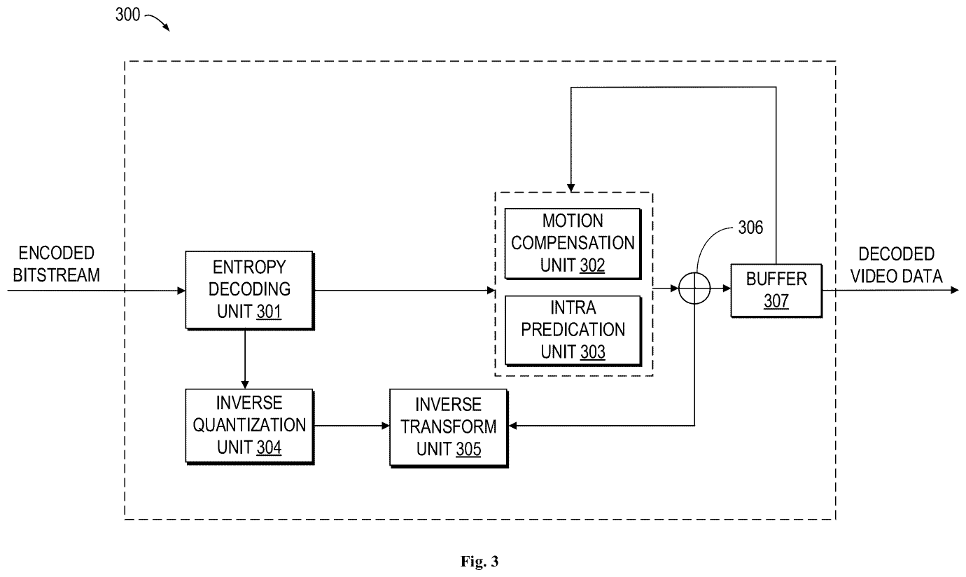

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is related to intra block copy (IBC), how to and/or whether to combine IBC with local illumination compensation, and other coding tools in image/video coding. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1 Coding Flow of a Typical Video Codec

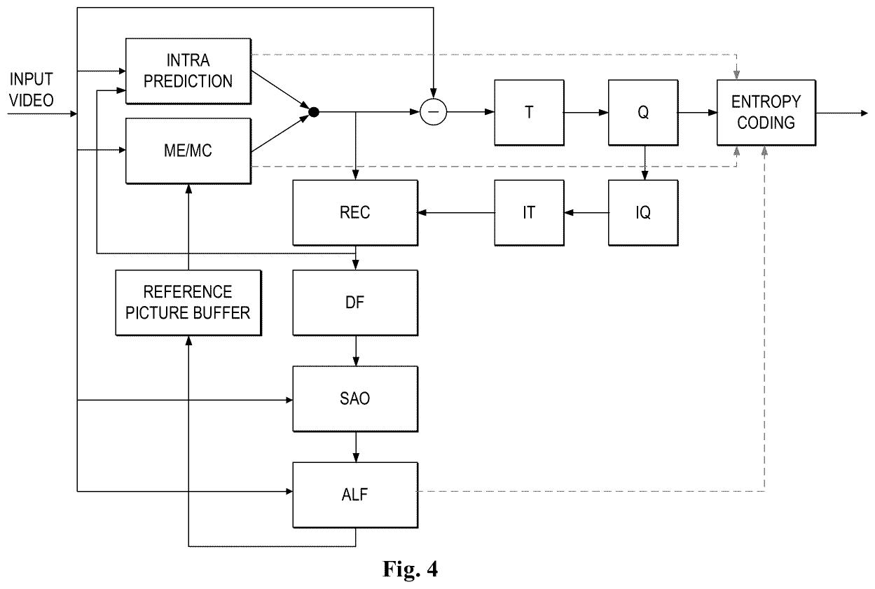

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.2 Intra Mode Coding with 67 Intra Prediction Modes

FIG. 5 illustrates 67 intra prediction modes. To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.
In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1 Wide Angle Intra Prediction

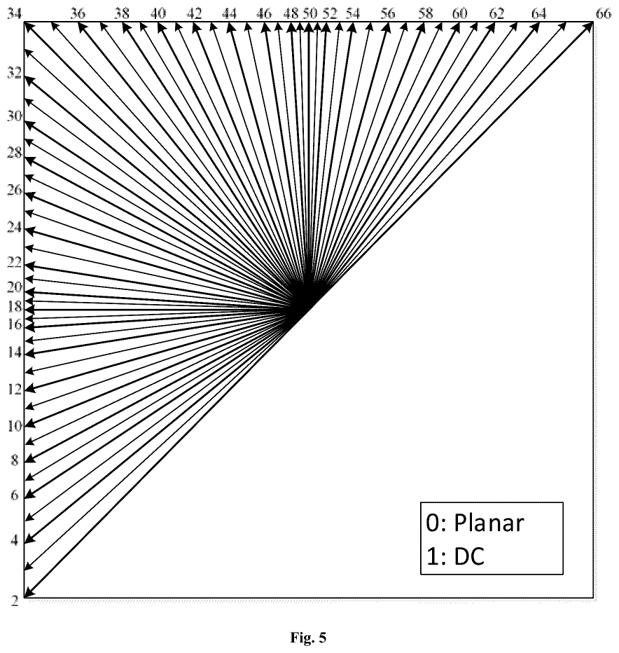

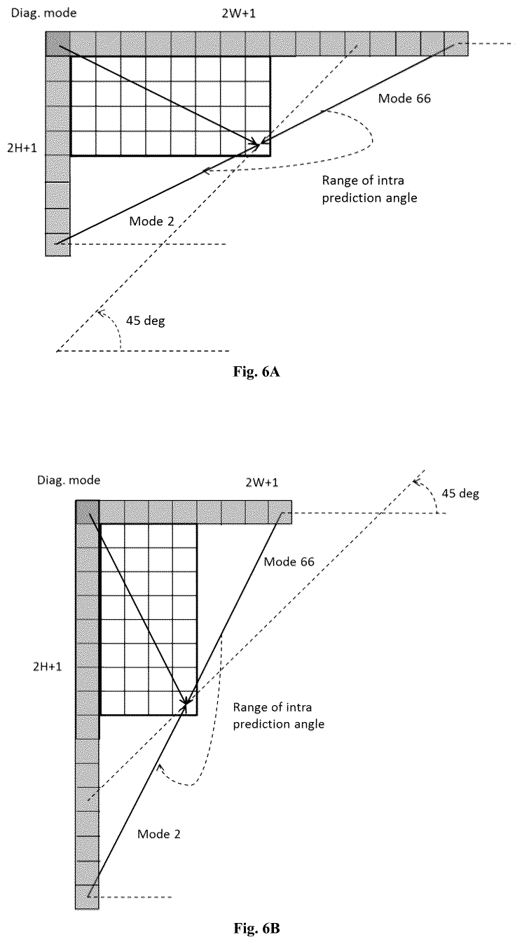

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.
FIG. 6A and FIG. 6B illustrate reference samples for wide-angular intra prediction To support these prediction directions, the top reference with length 2W+1, and the left reference with length 2H+1, are defined as shown in FIG. 6A and FIG. 6B. FIG. 6A and FIG. 6B illustrate reference samples for wide-angular intra prediction. The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, |
| | 61, 62, 63, 64, 65, 66 |
| W/H == 1/16 | Modes 53, 54, 55, 56, 57, 58, 59, |
| | 60, 61, 62, 63, 64, 65, 66 |

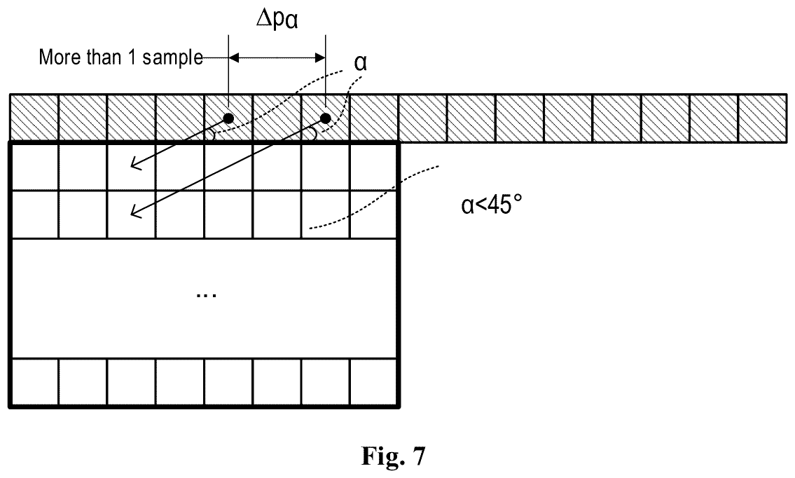

As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.
In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below-135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3 Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.
At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.
In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.
In block matching search, the search range is set to cover both the previous and current CTUs.
At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5 Merge Mode with MVD (MMVD)

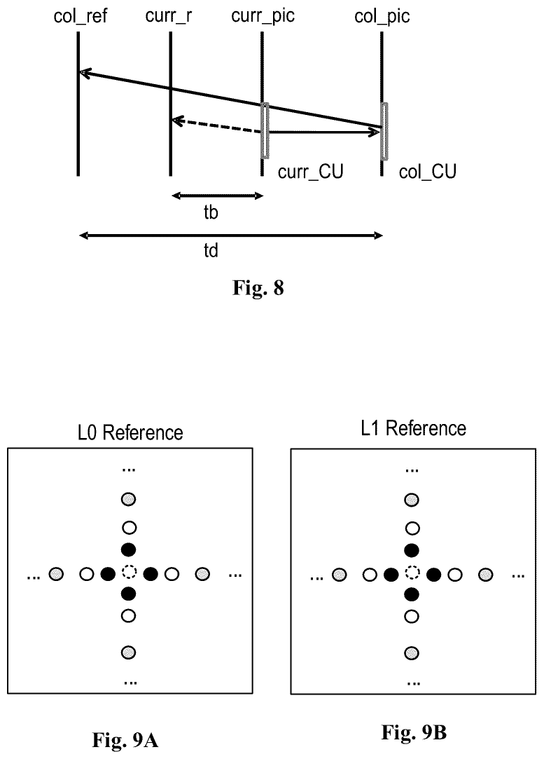

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.
In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates. FIG. 8 shows an illustration of motion vector scaling for temporal merge candidate. FIG. 9A and FIG. 9B illustrate examples of MMVD search point. Distance index specifies motion magnitude information and indicate the pre-defined offset from the starting point. As shown in FIG. 9A and FIG. 9B, an offset is added to either horizontal component or vertical component of starting MV. The relation of distance index and pre-defined offset is specified in Table 2.

TABLE 2
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 3 specifies the sign of MV offset added to the list0 MV component of starting MV and the sign for the list1 MV has opposite value. Otherwise, if the difference of POC in list 1 is greater than list 0, the sign in Table 3 specifies the sign of MV offset added to the list1 MV component of starting MV and the sign for the list0 MV has opposite value.
The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 8. If the POC difference of L1 is greater than L0, the MVD for list 0 is scaled in the same way. If the starting MV is uni-predicted, the MVD is added to the available MV.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.6 Local Illumination Compensation (LIC)

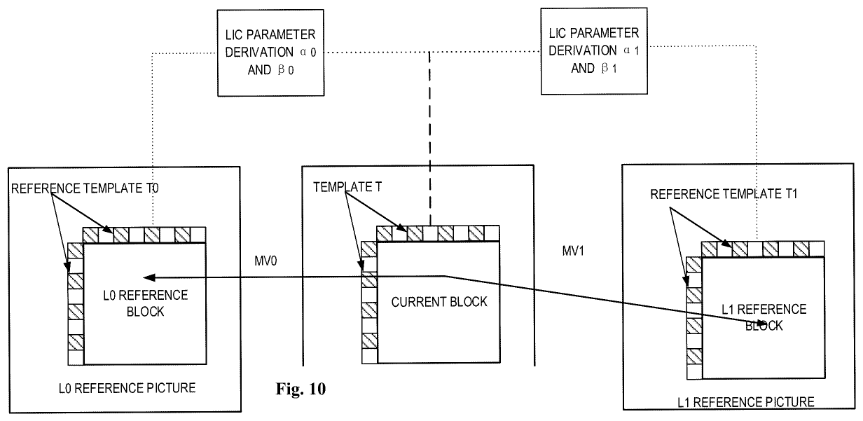

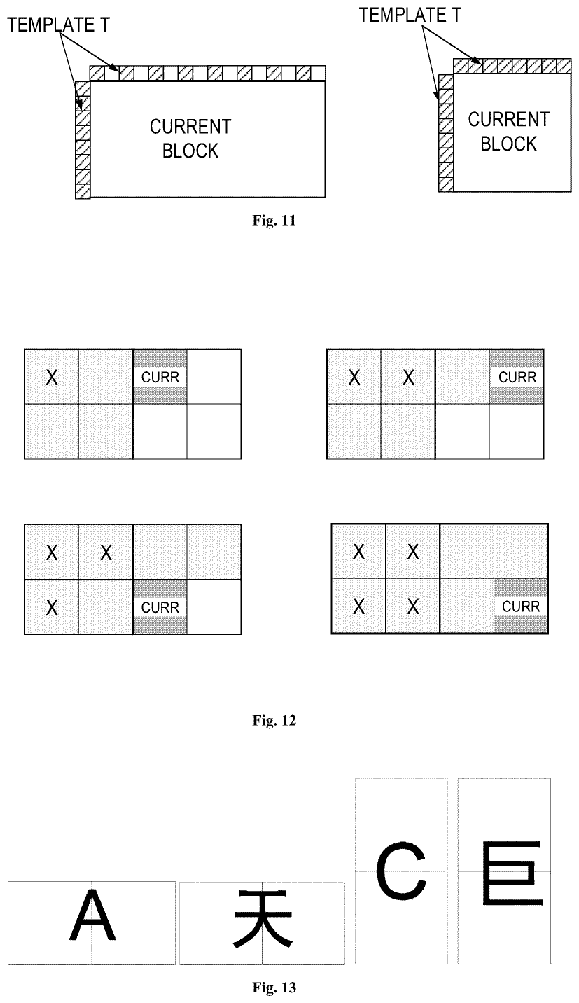

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 10 illustrates the LIC process. FIG. 10 illustrates an example of local illustration compensation. In FIG. 10, when the LIC is applied for a block, a least mean square error (LMSE) method is employed to derive the values of the LIC parameters (i.e., α and β) by minimizing the difference between the neighboring samples of the current block (i.e., the template T in FIG. 10) and their corresponding reference samples in the temporal reference pictures (i.e., either T0 or T1 in FIG. 10). Additionally, to reduce the computational complexity, both the template samples and the reference template samples are subsampled (adaptive subsampling) to derive the LIC parameters, i.e., only the shaded samples in FIG. 10 are used to derive α and β.
FIG. 11 illustrates no subsampling for the short side. To improve the coding performance, no subsampling for the short side is performed as shown in FIG. 11.

### 2.7 IBC with Template Matching

It is proposed to also use Template Matching with IBC for both IBC merge mode and IBC AMVP mode.
The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.
In the IBC-TM merge mode, the selected candidates are refined with the Template Matching method prior to the RDO or decoding process. The IBC-TM merge mode has been put in competition with the regular IBC merge mode and a TM-merge flag is signaled.
In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.
FIG. 12 illustrates IBC reference region depending on current CU position. The Template Matching refinement for both IBC-TM merge and AMVP modes is quite simple since IBC motion vectors are constrained to be integer and within a reference region as shown in FIG. 12. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

### 2.8 IBC Merge Mode with Block Vector Differences

IBC merge mode with block vector differences is shown as follows.
The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.
The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### 2.9 Reconstruction-Reordered IBC (RR-IBC)

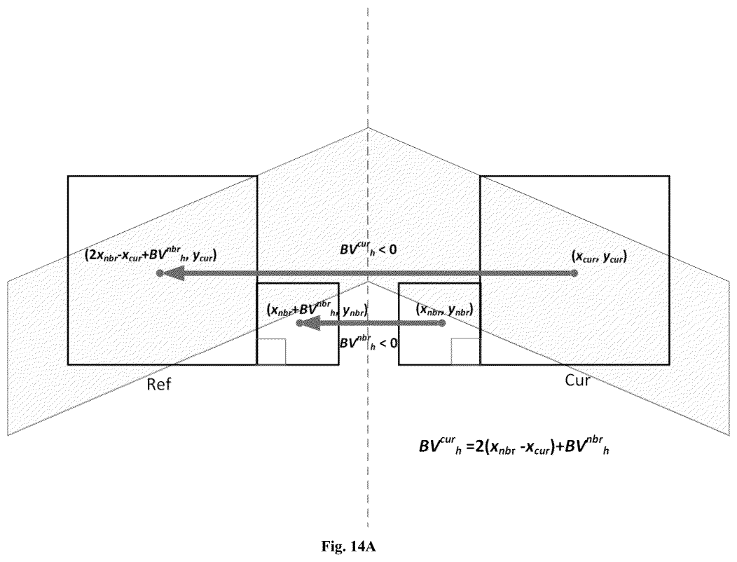

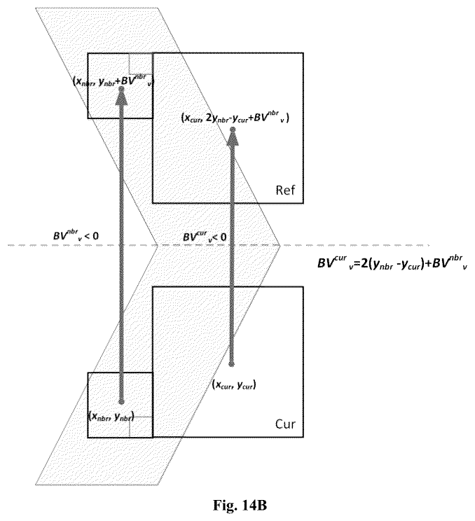

Screen content coding tools like Intra Block Copy (IBC) generate a prediction block by directly copying a prior coded reference region in the same picture. FIG. 13 illustrates examples of symmetry in screen content pictures. Symmetry is often observed in video content, especially in text character regions and computer-generated graphics in screen content sequences, as shown in FIG. 13. Therefore, a specific screen content coding tool considering the symmetry would be efficient to compress such kinds of video contents.
A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.
Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.
FIG. 14A illustrates an illustration of BV adjustment for horizontal flip. FIG. 14B illustrates an illustration of BV adjustment for vertical flip. To better utilize the symmetry property, a flip-aware BV adjustment approach is applied to refine the block vector candidate. For example, as shown in FIG. 14A and FIG. 14B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2 (x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

### 2.10 Intra Template Matching

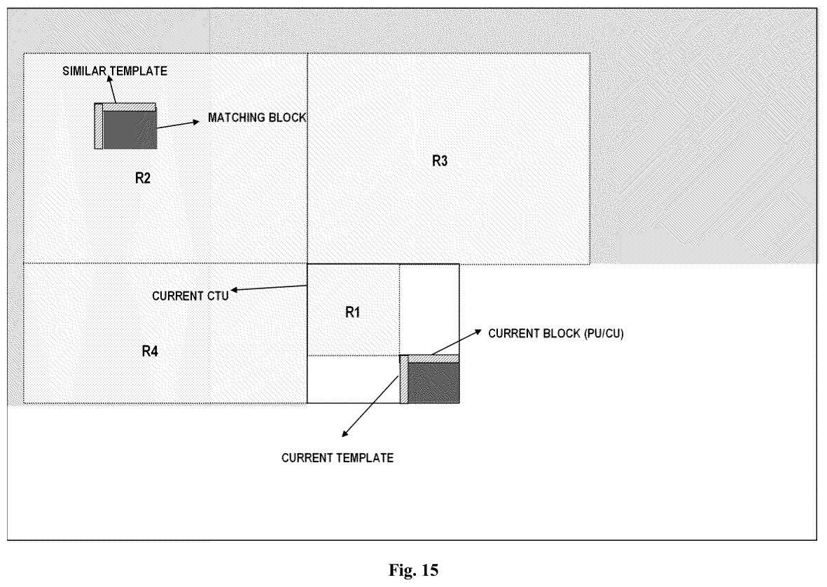

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.
FIG. 15 illustrates an intra template matching search area used. The prediction signal is generated by matching the L-shaped causal neighbor of the current block with another block in a predefined search area in FIG. 15 consisting of:
R1: current CTU,
R2: top-left CTU,
R3: above CTU,
R4: left CTU.
   SAD is used as a cost function.
   Within each region, the decoder searches for the template that has least SAD with respect to the current one and uses its corresponding block as a prediction block.
   The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.
The Intra template matching tool is enabled for CUs with size less than or equal to 64 in width and height. This maximum CU size for Intra template matching is configurable.
The Intra template matching prediction mode is signaled at CU level through a dedicated flag when DIMD is not used for current CU.

### 3. Problems

In current design of IBC, the whole block is directly copied from the reconstructed region in the current picture. However, when illumination change occurs within the current picture, the coding efficiency of IBC may be limited.

### 4. Detailed Solutions

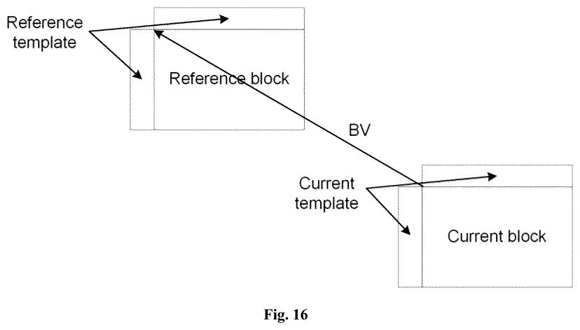

The detailed embodiments below should be considered as examples to explain general concepts. These embodiments should not be interpreted in a narrow way. Furthermore, these embodiments can be combined in any manner.
In the present disclosure, intra block copy (IBC) may not be limited to the current IBC technology, but may be interpreted as the technology that reference (or prediction) block is obtained with samples in the current slice/tile/subpicture/picture/other video unit (e.g., CTU row) excluding the conventional intra prediction methods.
In the present disclosure, local illumination compensation (LIC) may not be limited to the current LIC technology. LIC may refer to an inter prediction technique to model local illumination variation between current block and its prediction block as a function of that between current block template and reference block template. The parameters of the function may be denoted by a linear equation (e.g., α×p[x]+β) or a non-linear equation.
In the present disclosure, CIBCIP (or IBC-CIIP) may refer to a coding tool which combines of intra block copy (IBC) and intra prediction. It's a coding tool which obtain the prediction of a block using both IBC and intra prediction.
In the present disclosure, IBC-GPM may refer to a coding tool which obtains the prediction of at least one sub-partitions using IBC in a video unit when the video unit is divided into more than one sub-partitions geometrically.
In the following discussion, IBC may be replaced by other coding tools that rely on coded/decoded/reconstructed information within the same region, e.g., palette, intra template matching.
IBC with LIC
1. It is proposed that a refined prediction sample may be derived as f(p[x]), wherein p[x] denotes a prediction sample of the video unit, and f is any function.
   a. In one example, f(p[x])=α×p [x]+β, wherein α and β denotes the parameters of the linear equation.
   b. In one example, the function or at least one parameter of the function may be derived based on a template of the current block.
   c. In one example, the prediction sample may be derived by IBC.
      i. In one example, the function or at least one parameter of the function may be derived based on a template of the reference block of the current block, wherein the reference block may be located by a block vector (BV).
2. It is proposed that LIC may be applied to compensate the prediction (reconstruction) of a video unit, wherein IBC is used to obtain the prediction (reconstruction) of the video unit. It is denoted as IBC-LIC.
   a. In one example, a linear or non-linear equation/model may be used for IBC-LIC to compensate the prediction of the video unit.
      i. In one example, the linear equation may be α×p[x]+β, wherein p[x] denotes the prediction of the video unit, and α and β denotes the parameters of the linear equation.
   b. In one example, the parameters of the equation used in IBC-LIC may be pre-defined, or signalled in the bitstream.
   c. In one example, the parameters of the equation used in IBC-LIC may be derived using coding information.
      i. In one example, a current template consists of the neighbouring reconstructed (adjacent or non-adjacent) samples of the video unit and a reference template may be used to derive the parameters. An example is shown in FIG. 16.
         1) In one example, the reference template may be derived using the BV that is used to obtain the prediction of the video unit.
         2) In one example, partial or all samples of the current template and the reference template may be used to derive the parameters.
         3) In one example, a least square error method may be used to derive the parameters.
      ii. In one example, how to derive the parameters using the current template and the reference template may be same as LIC for inter prediction.
   d. In one example, partial or all prediction samples of the video unit may be compensated using IBC-LIC.
3. In one example, IBC-LIC may be applied to IBC AMVP mode and/or IBC merge mode.
   a. In one example, IBC AMVP mode may refer to normal IBC AMVP, or TM based IBC AMVP, or RR-IBC AMVP mode, or CIBCIP (IBC-CIIP), or IBC-GPM, or other IBC AMVP mode wherein a BV predictor is derived and BVD is signalled/derived.
   b. In one example, IBC merge mode may refer to normal IBC merge mode, or IBC-TM merge mode, or IBC-MBVD mode, or CIBCIP (IBC-CIIP), or IBC-GPM.
      i. In one example, IBC-LIC may be applied to a specific IBC merge candidate type.
      ii. In another example, IBC-LIC may be not allowed to apply to a specific IBC merge candidate type.
         1) In one example, the merge candidate type may refer to RR-IBC candidate.
   c. Alternatively, IBC-LIC may be not allowed to be applied to one or more of the above IBC coding tools.
      i. In one example, the IBC coding tool may refer to RR-IBC, or CIBCIP (IBC-CIIP), or IBC-GPM.
   d. In one example, whether to and/or how to apply IBC-LIC for IBC AMVP mode and/or IBC merge mode may be signalled or determined using coding information.
   e. In one example, one or more syntax elements may be signalled to indicate whether to and/or how to apply IBC-LIC for IBC AMVP mode and/or IBC merge mode.
   f. In one example, whether to and/or how to apply IBC-LIC for IBC merge mode may be inherited.
      i. In one example, the inheritance of whether to and/or how to apply IBC-LIC may be associated with the merge candidate.
         1) In one example, IBC-LIC may be disabled when a merge candidate is a specific merge type.
         a) In one example, the specific type may refer to RR-IBC.
4. In one example, whether to and/or how to apply IBC-LIC may depend on the coding information including:
   a. block dimensions and/or block size
   b. the coded information may refer to the depth of a block.
   c. slice/picture type and/or partition tree type (single, or dual tree, or local dual tree)
      i. In one example, IBC-LIC may be only applied to I slice/picture.
   d. block location
   e. quantization parameter
   f. colour component.
5. In one example, more than one LIC equations may be used to compensate the prediction (reconstruction) of a video unit which is derived using IBC.
   a. In one example, the multiple LIC types may refer to different LIC equations with adjustment parameters for one or more existing parameters of LIC (e.g., α and β).
      i. In one example, an adjustment parameter may be used to adjust α, such as α+u or α×u.
      ii. In one example, an adjustment parameter may be used to adjust β, such as β+v or β×v.
   b. In one example, the parameters of more than one LIC equations may be derived using different templates.
      i. In one example, different sample lines of the template may be used.
      ii. In one example, left, or above, or left-above templates may be used.
      iii. In one example, samples from different positions in the template may be used.
         1) In one example, the positions may refer to down-sampling positions.
      iv. In one example, samples in different categories may be used.
         1) In one example, the different categories may be classified depending on the samples of the template.
         2) In one example, a mean value of the samples in the template may be used to derive the different categories.
   c. In one example, whether to and how to apply one of the more than one LIC equations may be indicated using a syntax element which is signalled in the bitstream.
   d. In one example, whether to and how to apply one of the more than one LIC equations may be determined adaptively.
6. In one example, the positions/shape of the template may depend on coding information.
   a. In one example, if the left neighboring samples are unavailable, the template only contains the above neighbouring samples.
   b. In one example, if the above neighboring samples are unavailable, the template only contains the left neighbouring samples.
   c. In one example, if the left and above neighboring samples are unavailable, IBC-LIC may not be applicable.
   d. In one example, the template may refer to the template of the current block or the reference block.
   e. In one example, the positions/shape of the template may depend on whether RR-IBC or normal IBC is applied.
   f. In one example, the positions/shape of the template may consist of one or more sample lines.
   g. In one example, the positions/shape of the template may be pre-defined, or signalled, or derived on-the-fly.
   h. In one example, the positions/shape of the template may depend on the width and height of the video unit.
   i. In one example, the reference template may be constrained in the IBC buffer.
      i. Alternatively, the reference template may be not constrained in the IBC buffer.
7. The determination of whether a block is allowed to be coded with IBC-LIC mode may depend on coded information including:
   a. block dimensions and/or block size.
      i. In one example, the block is allowed to be coded with IBC-LIC mode when the block size (W×H) is less than or equal to a threshold (T), wherein W and H denotes block width and block height, respectively.
         1) In one example, T=256, or 512, or 1024, or 2048, or 4096.
   b. depth of a block.
   c. block location.
   d. slice/picture type.
   e. temporal layer (e.g., temporal layer index).
   f. colour format.
   g. colour component.
8. In one example, whether to and/or how to apply IBC-LIC may depend on colour format and/or colour components.
   a. In one example, IBC-LIC may apply to all colour components.
   b. In one example, whether to and/or how to apply IBC-LIC to a first component may depend on whether to apply IBC-LIC to a second component.
      i. In one example, the first component may refer to chroma component (e.g., Cb and/or Cr), and the second component may refer to luma component (e.g., Y).
      ii. In one example, the way to apply IBC-LIC to the first component may be same as the second component.
         1) Alternatively, the way to apply IBC-LIC to the first component may be different from the second component.
   c. In one example, IBC-LIC may apply to luma component, but not to chroma components.
      i. In one example, luma component may refer to Y in YCbCr colour space or G in RGB colour space.
      ii. In one example, chroma components may refer to Cb and/or Cr in YCbCr colour space or R and/or B in RGB colour space.

### On Signalling of IBC-LIC

9. Indication of the IBC-LIC mode may be conditionally signalled wherein the condition may include:
   a. whether a specific coding method is allowed, such as IBC (IBC AMVP or IBC merge), or RR-IBC, or CIBCIP (IBC-CIIP), or IBC-TM, or IBC-GPM
   b. block dimensions and/or block size
   c. block depth
   d. slice/picture type and/or partition tree type (single, or dual tree, or local dual tree)
   e. temporal layer identification
   f. block location
   g. colour component.
10. Whether current block is coded with IBC-LIC mode may be signalled using one or more syntax elements.
   a. In one example, the syntax element may be binarized with fixed length coding, or truncated unary coding, or unary coding, or EG coding, or coded a flag.
   b. In one example, the syntax element may be bypass coded or context coded.
      i. The context may depend on coded information, such as block dimensions, and/or block size, and/or slice/picture types, and/or the information of neighbouring blocks (adjacent or non-adjacent), and/or the information of other coding tools used for current block, and/or the information of temporal layer.
         1) In one example, the context may depend on whether the neighbouring blocks are coded with IBC-LIC.
   c. In one example, the indication of IBC-LIC mode may be signalled when current video unit is IBC coded.
   d. In one example, the syntax element may be signalled before or after the indication of a specific coding tool.
      i. In one example, the specific coding tool may refer to RR-IBC mode, or IBC-TM mode, or IBC-MBVD mode, or CIBCIP (IBC-CIIP), or IBC-GPM.
      ii. In one example, whether to signal and/or how to the syntax element may be dependent on whether IBC mode, RR-IBC mode, or IBC-TM mode, or IBC-MBVD mode, or CIBCIP (IBC-CIIP), or IBC-GPM is enabled for the video unit.
      iii. In one example, the syntax element may be signalled after the indication of RR-IBC mode.
         1) In one example, when RR-IBC mode is applied, the syntax element indicating IBC-LIC is not signalled and set to a default value which indicates IBC-LIC is not applied.
      iv. In one example, the syntax element may be signalled when the video unit is IBC-AMVP mode.
   e. In one example, the one or more syntax elements may be signalled at sequence header/picture header/SPS/VPS/DPS/DCI/PPS/APS/slice header/tile group header.
   f. In one example, the syntax element may be coded in a predictive way.
   g. For example, the syntax element of the current block may be predicted by that of a neighboring block.

### General Aspects

11. In above examples, the video unit may refer to the colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
12. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
13. Whether to and/or how to apply the disclosed methods above may be signalled at PB/TB/CB/PU/TU/CU/VPDU/CTU/CTU row/slice/tile/sub-picture/other kinds of region contains more than one sample or pixel.
14. Whether to and/or how to apply the disclosed methods above may be dependent on coded information, such as block size, colour format, single/dual tree partitioning, colour component, slice/picture type.

### 5. Embodiment

### 5.1 Embodiment 1

In this contribution, three aspects are proposed to extend the use of IBC:
Aspect #1: Combined IBC and intra prediction (IBC-CIIP);
Aspect #2: IBC with geometry partitioning (IBC-GPM);
Aspect #3: IBC with local illumination compensation (IBC-LIC).

### Combined IBC and Intra Prediction (IBC-CIIP)

When IBC-CIIP is applied to a CU, two prediction signals are obtained using IBC and intra prediction. The two prediction signals weighted summed to generate the final prediction. IBC-CIIP can be applied to IBC AMVP mode and IBC merge mode. A CU flag is signalled to indicate the use of IBC-CIIP.
IBC with Geometry Partitioning (IBC-GPM)
When IBC-GPM is applied to a CU, the CU is divided into two sub-partitions geometrically. The prediction signals of the two sub-partitions are generated using IBC and intra prediction. IBC-GPM can be applied to IBC merge mode. A CU flag is signalled to indicate the use of IBC-GPM.
IBC with Local Illumination Compensation (IBC-LIC)
When IBC-LIC is applied to a CU, local illumination variation between the CU and its prediction block is modelled as a linear equation. The parameters of the linear equation are derived similar to LIC for inter prediction. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “reference line” may refer to a row and/or a column reconstructed samples adjacent to or non-adjacent to the current block, which is used to derive the intra prediction of current video unit via an interpolation filter along a certain direction, and the certain direction is determined by an intra prediction mode (e.g., conventional intra prediction with intra prediction modes), or derive the intra prediction of current video unit via weighting the reference samples of the reference line with a matrix or vector (e.g., MIP).

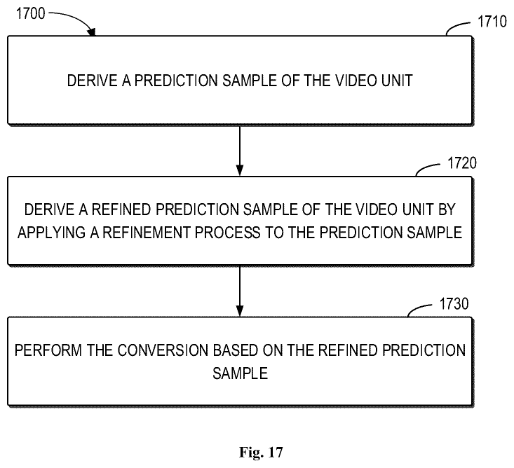

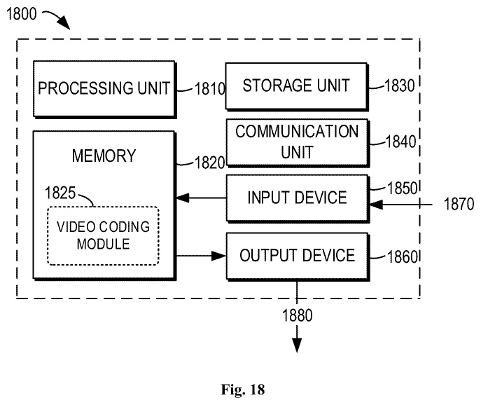

FIG. 17 illustrates a flowchart of a method 1700 for video processing in accordance with embodiments of the present disclosure. The method 1700 is implemented during a conversion between a video unit of a video and a bitstream of the video.

At block 1710, for a conversion between a video unit of a video and a bitstream of the video, a prediction sample of the video unit is derived.

At block 1720, a refined prediction sample of the video unit is derived by applying a refinement process to the prediction sample.

At block 1730, the conversion is performed based on the refined prediction sample. In some embodiments, the conversion may include encoding the video unit into the bitstream. Alternatively, or in addition, the conversion may include decoding the video unit from the bitstream. In this way, it can improve coding efficiency and coding performance.

In some embodiments, the refined prediction sample is derived as: f(p[x])=α×p[x]+β. In this case, f(p[x]) represents the refined prediction sample, p[x] represents the prediction sample, f represents the refinement process which is a function, α and β represent parameters of a linear model, respectively.

In some embodiments, a function of the refinement process is derived based on a template of a current block associated with the video unit. Alternatively, at least one parameter of the function of the refinement process is derived based on the template of the current block associated with the video unit.

In some embodiments, the prediction sample is derived by intra block copy (IBC). In some embodiments, a function of the refinement process or at least one parameter of the function is derived based on a template of a reference block associated with the video unit. The reference block may be located by a block vector.

In some embodiments, the refinement process comprises a local illumination compensation (LIC). The refined prediction sample may be obtained based on an IBC with the LIC.

In some embodiments, the method comprises: deriving the prediction sample of the video unit by applying the IBC; and deriving the refined prediction sample of the video unit by applying the LIC to compensate the prediction sample of the video unit. For example, LIC may be applied to compensate the prediction (reconstruction) of a video unit, wherein IBC is used to obtain the prediction (reconstruction) of the video unit. It is denoted as IBC-LIC.

In some embodiments, a linear model is used for the IBC with LIC to compensate the prediction sample of the video unit. Alternatively, a non-linear model is used for the IBC with LIC to compensate the prediction sample of the video unit. In some embodiments, the linear model is represented as: α×p[x]+β, wherein p[x] represents the prediction sample of the video unit, and α and β represent parameters of the linear model, respectively.

In some embodiments, parameters of a model used in the IBC with LIC are predefined or indicated in the bitstream. In some embodiments, parameters of a model used in the IBC with LIC are derived based on coding information of the video unit.

In some embodiments, a current template comprising neighboring reconstructed samples of the video unit and a reference template are used to derive the parameters. In one example, a current template includes the neighboring reconstructed (adjacent or non-adjacent) samples of the video unit and a reference template may be used to derive the parameters. An example is shown in FIG. 16.

In some embodiments, the reference template is derived using a BV that is used to obtain the prediction sample of the video unit. In some embodiments, a portion or all samples of the current template and the reference template are used to derive the parameters. In some embodiments, a least square error method is used to derive the parameters. In some embodiments, an approach to derive the parameters using a current template and a reference template of the video unit is same as LIC for inter prediction. In some embodiments, a portion or all prediction samples of the video unit are compensated using the IBC with LIC.

In some embodiments, the IBC with LIC is applied to at least one of an IBC advanced motion vector prediction (AMVP) mode, or an IBC merge mode. In some embodiments, the IBC AMVP mode comprises at least one of: a normal IBC AMVP mode, a template matching (TM) based IBC AMVP mode, a reconstruction-reordered IBC (RR-IBC) AMVP mode, a combined IBC and intra prediction (IBC-CIIP) mode, an IBC with geometry partitioning mode (IBC-GPM) mode, or other IBC AMVP mode where a V predictor is derived and block vector difference (BVD) is indicated or derived.

In some embodiments, the IBC merge mode comprises at least one of a normal IBC merge mode, an IBC-TM merge mode, an IBC-merge mode with block vector difference (MBVD) mode, an IBC-CIIP mode, or an IBC-GPM mode. In some embodiments, the IBC with LIC is applied to an IBC merge candidate type. Alternatively, the IBC with LIC is not allowed to apply to the IBC merge candidate type. In some embodiments, the IBC merge candidate type comprises an RR-IBC candidate.

In some embodiments, the IBC with LIC is not allowed to be applied to at least one IBC coding tool. In some embodiments, the at least one IBC coding tool comprises one or more of: an RR-IBC, an IBC-CIIP, or an IBC-GPM.

In some embodiments, whether to and/or an approach to apply the IBC with LIC for at least one of an IBC AMVP mode or an IBC merge mode is indicated. Alternatively, whether to and/or an approach to apply the IBC with LIC for at least one of an IBC AMVP mode or an IBC merge mode is determined based on coding information of the video unit.

In some embodiments, at least one syntax element is indicated to indicate whether to and/or an approach to apply the IBC with LIC for at least one of an IBC AMVP mode or an IBC merge mode.

In some embodiments, whether to and/or an approach to apply the IBC with LIC for an IBC merge mode is inherited. In some embodiments, an inheritance of whether to and/or the approach to apply the IBC with LIC is associated with a merge candidate.

In some embodiments, the IBC with LIC is disabled when a merge candidate belongs to a target merge type. In some embodiments, the target merge type is an RR-IBC.

In some embodiments, whether to and/or an approach to apply IBC with LIC depends on coding information of the video unit. For example, the coding information of the video unit comprises at least one of: a block dimension, a block size, a depth of the video unit, a slice type, a picture type, a partition tree type, a block location, a quantization parameter, or a colour component. In some embodiments, the IBC with LIC is only applied to an I slice or I picture.

In some embodiments, the refinement process comprises a plurality of LIC models. The plurality of LIC models may be used to compensate the prediction sample of the video unit which is derived using IBC.

In some embodiments, a plurality of LIC types comprises different LIC models with adjustment parameters for one or more existing parameters of LIC. In one example, the multiple LIC types may refer to different LIC equations with adjustment parameters for one or more existing parameters of LIC (e.g., α and β).

In some embodiments, an adjustment parameter is used to adjust α which is an existing parameter of LIC. For example, a is adjusted as α+u or α×u, and where u is the adjustment parameter. In some embodiments, an adjustment parameter is used to adjust β which is an existing parameter of LIC. For example, β is adjusted as β+v or β×v, and where v is the adjustment parameter.

In some embodiments, parameters of the plurality of LIC models are derived using different templates. In some embodiments, different sample lines of a template are used for deriving the parameters of the plurality of LIC models. In some embodiments, at least one of the followings is used for deriving the parameters of the plurality of LIC models: a left template, an above template, or a left-above template.

In some embodiments, samples from different positions in a template are used for deriving the parameters of the plurality of LIC models. In some embodiments, the different positions comprise down-sampling positions.

In some embodiments, samples in different categories are used for deriving the parameters of the plurality of LIC models. In some embodiments, the different categories are classified depending on samples of a template. In some embodiments, a mean value of samples in a template is used to derive the different categories.

In some embodiments, whether to and/or an approach to apply one of the plurality of LIC models is indicated using a syntax element which is indicated in the bitstream. In some embodiments, whether to and/or an approach to apply one of the plurality of LIC models is determined adaptively.

In some embodiments, positions or a shape of a template depends on coding information of the video unit. In some embodiments, if left neighboring samples are unavailable, the template only comprises above neighboring samples. In some embodiments, if above neighboring samples are unavailable, the template only comprises left neighboring samples. In some embodiments, if left and above neighboring samples are unavailable, the IBC with LIC is not applicable. In some embodiments, the template comprises a template of a current block or a template of a reference block associated with the video unit.

In some embodiments, positions or a shape of a template depend on whether an RR-IBC or a normal IBC is applied. In some embodiments, positions or a shape of a template comprises one or more sample lines.

In some embodiments, positions or a shape of a template is pre-defined. Alternatively, the positions or the shape of the template is indicated. In some other embodiments, the positions or the shape of the template is derived on-the-fly. In some embodiments, positions or a shape of a template depends on a width and/or height of the video unit.

In some embodiments, a reference template is constrained in an IBC buffer. Alternatively, the reference template is not constrained in the IBC buffer.

In some embodiments, the method further includes: determining whether the video unit is allowed to be coded with an IBC with LIC mode based on coded information of the video unit. In some embodiments, the coded information comprises at least one of: a block dimension, a block size, a depth of a block, a block location, a slice type, a picture type, a temporal layer, a colour format, or a colour component.

In some embodiments, if the block size that is represented as WH is less than or equal to a threshold, the video unit is allowed to be coded with the IBC with LIC mode, where W represents a block width of the video unit and H represents a block height of the video unit. In some embodiments, the threshold is one of: 256, or 512, or 1024, or 2048, or 4096.

In some embodiments, whether to and/or an approach to apply an IBC with LIC depends on at least one of: a colour format or colour components. In some embodiments, the IBC with LIC is applied to all colour components.

In some embodiments, whether to and/or an approach to apply the IBC with LIC to a first component depends on whether to apply the IBC with LIC to a second component. In some embodiments, the first component comprises a chroma component (for example, Cb and/or Cr) and the second component comprises a luma component (for example, Y).

In some embodiments, the approach to apply the IBC with LIC to the first component is same as the approach to apply the IBC with LIC to the second component. Alternatively, the approach to apply the IBC with LIC to the first component is different from the approach to apply the IBC with LIC to the second component.

In some embodiments, the IBC with LIC is applied to luma component, but not to chroma components. In some embodiments, the luma component comprises Y in YCbCr colour space or G in RGB colour space. In some embodiments, the chroma components comprise at least one of: Cb or Cr in YCbCr colour space. Alternatively, the chroma components comprise at least one of: R or B in RGB colour space.

In some embodiments, an indication of the IBC with LIC mode is indicated based on a condition. In some embodiments, the condition comprises at least one of: whether a target coding method is allowed, a block dimension, a block size, a block depth, a slice type, a picture type, a partition tree type, a temporal layer identification, a block location, or a colour component. In some embodiments, the target coding method comprises at least one of: an IBC, an IBC AMVP, an IBC merge, an RR-IBC, an IBC-CIIP, an IBC-TM, or an IBC-GPM.

In some embodiments, whether the video unit is coded with an IBC with LIC mode is indicated using at least one syntax element. In some embodiments, the at least one syntax element is binarized with one of: fixed length coding, truncated unary coding, unary coding, EG coding, or coded a flag.

In some embodiments, the at least one syntax element is bypass coded or context coded. In some embodiments, the context depends on coded information of the video unit. For example, the coded information comprises at least one of; a block dimension, a block size, a slice type, a picture types, information of neighboring blocks, information of other coding tools used for a current block, or information of temporal layer. In some embodiments, the context depends on whether neighboring blocks are coded with the IBC with LIC mode.

In some embodiments, if the video unit is IBC coded, an indication of the IBC with LIC mode is indicated. In one example, the indication of IBC-LIC mode may be signalled when current video unit is IBC coded.

In some embodiments, the at least one syntax element is indicated before an indication of a target coding tool. Alternatively, the at least one syntax element is indicated after the indication for the target coding tool.

In some embodiments, the target coding tool comprises at least one of: an RR-IBC mode, an IBC-TM mode, an IBC-MBVD mode, an IBC-CIIP, or an IBC-GPM. In some embodiments, whether to and/or an approach to indicate the at least one syntax element is dependent on whether at least one of: an IBC mode, an RR-IBC mode, an IBC-TM mode, an IBC-MBVD mode, an IBC-CIIP, or an IBC-GPM is enabled for the video unit.

In some embodiments, the at least one syntax element is indicated after an indication of RR-IBC mode. In some embodiments, if the RR-IBC mode is applied, the at least one syntax element indicating the IBC with LIC is not indicated and set to a default value which indicates the IBC with LIC is not applied.

In some embodiments, if the video unit is coded with IBC-AMVP mode, the at least one syntax element is indicated. In one example, the syntax element may be signalled when the video unit is IBC-AMVP mode.

In some embodiments, the at least one syntax element is indicated at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the at least one syntax element is coded in a predictive way. In some embodiments, the at least one syntax element of a current block of the video unit is predicted by that of a neighboring block.

In some embodiments, the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

In some embodiments, an indication of whether to and/or how to derive a refined prediction sample of the video unit by applying a refinement process to the prediction sample is indicated at one of the followings: sequence level, group of pictures level, picture level, slice level, or tile group level.

In some embodiments, an indication of whether to and/or how to derive a refined prediction sample of the video unit by applying a refinement process to the prediction sample is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to derive a refined prediction sample of the video unit by applying a refinement process to the prediction sample is indicated at one of the following: a PB, a TB, a CB, a PU, a TU, a CU, a VPDU, a CTU, a CTU row, a slice, a tile, a sub-picture, or a region contains more than one sample or pixel.

In some embodiments, whether to and/or how to derive a refined prediction sample of the video unit by applying a refinement process to the prediction sample is coded information of the video unit, and the coded information comprises at least one of a block size, a colour format, a single tree partitioning, a dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: deriving a prediction sample of a video unit of the video; deriving a refined prediction sample of the video unit by applying a refinement process to the prediction sample; and generating the bitstream based on the refined prediction sample.

According to still further embodiments of the present disclosure, a method for storing bitstream of a video is provided. The method comprises: deriving a prediction sample of a video unit of the video; deriving a refined prediction sample of the video unit by applying a refinement process to the prediction sample; generating the bitstream based on the refined prediction sample; and storing the bitstream in a non-transitory computer-readable recording medium.

Implementations of the present disclosure can be described in view of the following clauses, the features of which can be combined in any reasonable manner.

Clause 1. A method of video processing, comprising: deriving, for a conversion between a video unit of a video and a bitstream of the video, a prediction sample of the video unit; deriving a refined prediction sample of the video unit by applying a refinement process to the prediction sample; and performing the conversion based on the refined prediction sample.

Clause 2. The method of clause 1, wherein the refined prediction sample is derived as: f(p[x])=α×p[x]+β, wherein f(p[x]) represents the refined prediction sample, p[x] represents the prediction sample, f represents the refinement process which is a function, α and β represent parameters of a linear model, respectively.

Clause 3. The method of clause 1, wherein a function of the refinement process is derived based on a template of a current block associated with the video unit, or wherein at least one parameter of the function of the refinement process is derived based on the template of the current block associated with the video unit.

Clause 4. The method of clause 1, wherein the prediction sample is derived by intra block copy (IBC).

Clause 5. The method of clause 4, wherein a function of the refinement process or at least one parameter of the function is derived based on a template of a reference block associated with the video unit, and wherein the reference block is located by a block vector.

Clause 6. The method of clause 1, wherein the refinement process comprises a local illumination compensation (LIC), and wherein the refined prediction sample is obtained based on an IBC with the LIC.

Clause 7. The method of clause 6, wherein the method comprises: deriving the prediction sample of the video unit by applying the IBC; and deriving the refined prediction sample of the video unit by applying the LIC to compensate the prediction sample of the video unit.

Clause 8. The method of clause 6, wherein a linear model is used for the IBC with LIC to compensate the prediction sample of the video unit, or wherein a non-linear model is used for the IBC with LIC to compensate the prediction sample of the video unit.

Clause 9. The method of clause 8, wherein the linear model is represented as: α×p[x]+β, wherein p[x] represents the prediction sample of the video unit, and α and β represent parameters of the linear model, respectively.

Clause 10. The method of clause 6, wherein parameters of a model used in the IBC with LIC are predefined or indicated in the bitstream.

Clause 11. The method of clause 6, wherein parameters of a model used in the IBC with LIC are derived based on coding information of the video unit.

Clause 12. The method of clause 11, wherein a current template comprising neighboring reconstructed samples of the video unit and a reference template are used to derive the parameters.

Clause 13. The method of clause 12, wherein the reference template is derived using a BV that is used to obtain the prediction sample of the video unit.

Clause 14. The method of clause 12, wherein a portion or all samples of the current template and the reference template are used to derive the parameters.

Clause 15. The method of clause 12, wherein a least square error method is used to derive the parameters.

Clause 16. The method of clause 6, wherein an approach to derive the parameters using a current template and a reference template of the video unit is same as LIC for inter prediction.

Clause 17. The method clause 6, wherein a portion or all prediction samples of the video unit are compensated using the IBC with LIC.

Clause 18. The method of clause 6, wherein the IBC with LIC is applied to at least one of an IBC advanced motion vector prediction (AMVP) mode, or an IBC merge mode.

Clause 19. The method of clause 18, wherein the IBC AMVP mode comprises at least one of: a normal IBC AMVP mode, a template matching (TM) based IBC AMVP mode, a reconstruction-reordered IBC (RR-IBC) AMVP mode, a combined IBC and intra prediction (IBC-CIIP) mode, an IBC with geometry partitioning mode (IBC-GPM) mode, or other IBC AMVP mode where a BV predictor is derived and block vector difference (BVD) is indicated or derived.

Clause 20. The method of clause 18, wherein the IBC merge mode comprises at least one of a normal IBC merge mode, an IBC-TM merge mode, an IBC-merge mode with block vector difference (MBVD) mode, an IBC-CIIP mode, or an IBC-GPM mode.

Clause 21. The method of clause 6, wherein the IBC with LIC is applied to an IBC merge candidate type, or wherein the IBC with LIC is not allowed to apply to the IBC merge candidate type.

Clause 22. The method of clause 21, wherein the IBC merge candidate type comprises an RR-IBC candidate.

Clause 23. The method of clause 6, wherein the IBC with LIC is not allowed to be applied to at least one IBC coding tool.

Clause 24. The method of clause 23, wherein the at least one IBC coding tool comprises one or more of: an RR-IBC, an IBC-CHIP, or an IBC-GPM.

Clause 25. The method of clause 6, wherein whether to and/or an approach to apply the IBC with LIC for at least one of an IBC AMVP mode or an IBC merge mode is indicated, or wherein whether to and/or an approach to apply the IBC with LIC for at least one of an IBC AMVP mode or an IBC merge mode is determined based on coding information of the video unit.

Clause 26. The method of clause 6, wherein at least one syntax element is indicated to indicate whether to and/or an approach to apply the IBC with LIC for at least one of an IBC AMVP mode or an IBC merge mode.

Clause 27. The method of clause 6, wherein whether to and/or an approach to apply the IBC with LIC for an IBC merge mode is inherited.

Clause 28. The method of clause 27, wherein an inheritance of whether to and/or the approach to apply the IBC with LIC is associated with a merge candidate.

Clause 29. The method of clause 28, wherein the IBC with LIC is disabled when a merge candidate belongs to a target merge type.

Clause 30. The method of clause 29, wherein the target merge type is an RR-IBC.

Clause 31. The method of clause 6, wherein whether to and/or an approach to apply IBC with LIC depends on coding information of the video unit.

Clause 32. The method of clause 31, wherein the coding information of the video unit comprises at least one of: a block dimension, a block size, a depth of the video unit, a slice type, a picture type, a partition tree type, a block location, a quantization parameter, or a colour component.

Clause 33. The method of clause 32, wherein the IBC with LIC is only applied to an I slice or I picture.

Clause 34. The method of clause 1, wherein the refinement process comprises a plurality of LIC models, and the plurality of LIC models is used to compensate the prediction sample of the video unit which is derived using IBC.

Clause 35. The method of clause 34, wherein a plurality of LIC types comprises different LIC models with adjustment parameters for one or more existing parameters of LIC.

Clause 36. The method of clause 35, wherein an adjustment parameter is used to adjust α which is an existing parameter of LIC.

Clause 37. The method of clause 36, wherein α is adjusted as α+u or α×u, and wherein u is the adjustment parameter.

Clause 38. The method of clause 35, wherein an adjustment parameter is used to adjust β which is an existing parameter of LIC.

Clause 39. The method of clause 38, where β is adjusted as β+v or β×v, and wherein v is the adjustment parameter.

Clause 40. The method of clause 34, wherein parameters of the plurality of LIC models are derived using different templates.

Clause 41. The method of clause 40, wherein different sample lines of a template are used for deriving the parameters of the plurality of LIC models.

Clause 42. The method of clause 40, wherein at least one of the followings is used for deriving the parameters of the plurality of LIC models: a left template, an above template, or a left-above template.

Clause 43. The method of clause 40, wherein samples from different positions in a template are used for deriving the parameters of the plurality of LIC models.

Clause 44. The method of clause 43, wherein the different positions comprise down-sampling positions.

Clause 45. The method of clause 40, wherein samples in different categories are used for deriving the parameters of the plurality of LIC models.

Clause 46. The method of clause 45, wherein the different categories are classified depending on samples of a template.

Clause 47. The method of clause 45, wherein a mean value of samples in a template is used to derive the different categories.

Clause 48. The method of clause 34, wherein whether to and/or an approach to apply one of the plurality of LIC models is indicated using a syntax element which is indicated in the bitstream.

Clause 49. The method of clause 34, wherein whether to and/or an approach to apply one of the plurality of LIC models is determined adaptively.

Clause 50. The method of clause 1, wherein positions or a shape of a template depends on coding information of the video unit.

Clause 51. The method of clause 50, wherein if left neighboring samples are unavailable, the template only comprises above neighboring samples.

Clause 52. The method of clause 50, wherein if above neighboring samples are unavailable, the template only comprises left neighboring samples.

Clause 53. The method of clause 50, wherein if left and above neighboring samples are unavailable, the IBC with LIC is not applicable.

Clause 54. The method of clause 50, wherein the template comprises a template of a current block or a template of a reference block associated with the video unit.

Clause 55. The method of clause 1, wherein positions or a shape of a template depend on whether an RR-IBC or a normal IBC is applied.

Clause 56. The method of clause 1, wherein positions or a shape of a template comprises one or more sample lines.

Clause 57. The method of clause 1, wherein positions or a shape of a template is pre-defined, or wherein the positions or the shape of the template is indicated, or wherein the positions or the shape of the template is derived on-the-fly.

Clause 58. The method of clause 1, wherein positions or a shape of a template depends on a width and/or height of the video unit.

Clause 59. The method of clause 1, wherein a reference template is constrained in an IBC buffer, or wherein the reference template is not constrained in the IBC buffer.

Clause 60. The method of clause 1, further comprising determining whether the video unit is allowed to be coded with an IBC with LIC mode based on coded information of the video unit.

Clause 61. The method of clause 60, wherein the coded information comprises at least one of: a block dimension, a block size, a depth of a block, a block location, a slice type, a picture type, a temporal layer, a colour format, or a colour component.

Clause 62. The method of clause 61, wherein if the block size that is represented as WH is less than or equal to a threshold, the video unit is allowed to be coded with the IBC with LIC mode, wherein W represents a block width of the video unit and H represents a block height of the video unit.

Clause 63. The method of clause 62, wherein the threshold is one of: 256, or 512, or 1024, or 2048, or 4096.

Clause 64. The method of clause 1, wherein whether to and/or an approach to apply an IBC with LIC depends on at least one of: a colour format or colour components.

Clause 65. The method of clause 64, wherein the IBC with LIC is applied to all colour components.

Clause 66. The method of clause 64, wherein whether to and/or an approach to apply the IBC with LIC to a first component depends on whether to apply the IBC with LIC to a second component.

Clause 67. the method of clause 66, wherein the first component comprises a chroma component and the second component comprises a luma component.

Clause 68. The method of clause 66, wherein the approach to apply the IBC with LIC to the first component is same as the approach to apply the IBC with LIC to the second component.

Clause 69. The method of clause 66, wherein the approach to apply the IBC with LIC to the first component is different from the approach to apply the IBC with LIC to the second component.

Clause 70. The method of clause 64, wherein the IBC with LIC is applied to luma component, but not to chroma components.

Clause 71. The method of clause 70, wherein the luma component comprises Y in YCbCr colour space or G in RGB colour space.

Clause 72. The method of clause 70, wherein the chroma components comprise at least one of: Cb or Cr in YCbCr colour space, or wherein the chroma components comprise at least one of: R or B in RGB colour space.

Clause 73. The method of clause 1, wherein an indication of the IBC with LIC mode is indicated based on a condition.

Clause 74. The method of clause 73, wherein the condition comprises at least one of: whether a target coding method is allowed, a block dimension, a block size, a block depth, a slice type, a picture type, a partition tree type, a temporal layer identification, a block location, or a colour component.

Clause 75. The method of clause 74, wherein the target coding method comprises at least one of: an IBC, an IBC AMVP, an IBC merge, an RR-IBC, an IBC-CIIP, an IBC-TM, or an IBC-GPM.

Clause 76. The method of clause 1, wherein whether the video unit is coded with an IBC with LIC mode is indicated using at least one syntax element.

Clause 77. The method of clause 76, wherein the at least one syntax element is binarized with one of: fixed length coding, truncated unary coding, unary coding, EG coding, or coded a flag.

Clause 78. The method of clause 76, wherein the at least one syntax element is bypass coded or context coded.

Clause 79. The method of clause 78, wherein the context depends on coded information of the video unit.

Clause 80. The method of clause 79, wherein the coded information comprises at least one of; a block dimension, a block size, a slice type, a picture types, information of neighboring blocks, information of other coding tools used for a current block, or information of temporal layer.

Clause 81. The method of clause 78, wherein the context depends on whether neighboring blocks are coded with the IBC with LIC mode.

Clause 82. The method of clause 76, wherein if the video unit is IBC coded, an indication of the IBC with LIC mode is indicated.

Clause 83. The method of clause 76, wherein the at least one syntax element is indicated before an indication of a target coding tool, or wherein the at least one syntax element is indicated after the indication for the target coding tool.

Clause 84. The method of clause 83, wherein the target coding tool comprises at least one of: an RR-IBC mode, an IBC-TM mode, an IBC-MBVD mode, an IBC-CIIP, or an IBC-GPM.

Clause 85. The method of clause 83, wherein whether to and/or an approach to indicate the at least one syntax element is dependent on whether at least one of: an IBC mode, an RR-IBC mode, an IBC-TM mode, an IBC-MBVD mode, an IBC-CIIP, or an IBC-GPM is enabled for the video unit.

Clause 86. The method of clause 83, wherein the at least one syntax element is indicated after an indication of RR-IBC mode.

Clause 87. The method of clause 86, wherein if the RR-IBC mode is applied, the at least one syntax element indicating the IBC with LIC is not indicated and set to a default value which indicates the IBC with LIC is not applied.

Clause 88. The method of clause 76, wherein if the video unit is coded with IBC-AMVP mode, the at least one syntax element is indicated.

Clause 89. The method of clause 76, wherein the at least one syntax element is indicated at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 90. The method of clause 76, wherein the at least one syntax element is coded in a predictive way.

Clause 91. The method of clause 76, wherein the at least one syntax element of a current block of the video unit is predicted by that of a neighboring block.

Clause 92. The method of any of clauses 1-91, wherein the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

Clause 93. The method of any of clauses 1-92, wherein an indication of whether to and/or how to derive a refined prediction sample of the video unit by applying a refinement process to the prediction sample is indicated at one of the followings: sequence level, group of pictures level, picture level, slice level, or tile group level.

Clause 94. The method of any of clauses 1-92, wherein an indication of whether to and/or how to derive a refined prediction sample of the video unit by applying a refinement process to the prediction sample is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 95. The method of any of clauses 1-92, wherein an indication of whether to and/or how to derive a refined prediction sample of the video unit by applying a refinement process to the prediction sample is indicated at one of the following: a PB, a TB, a CB, a PU, a TU, a CU, a VPDU, a CTU, a CTU row, a slice, a tile, a sub-picture, or a region contains more than one sample or pixel.

Clause 96. The method of any of clauses 1-92, wherein whether to and/or how to derive a refined prediction sample of the video unit by applying a refinement process to the prediction sample is coded information of the video unit, and wherein the coded information comprises at least one of a block size, a colour format, a single tree partitioning, a dual tree partitioning, a colour component, a slice type, or a picture type.

Clause 97. The method of any of clauses 1-96, wherein the conversion includes encoding the video unit into the bitstream.

Clause 98. The method of any of clauses 1-96, wherein the conversion includes decoding the video unit from the bitstream.

Clause 99. An apparatus for video processing comprising a processor and a non-transitory memory with instructions thereon, wherein the instructions upon execution by the processor, cause the processor to perform a method in accordance with any of clauses 1-98.

Clause 100. A non-transitory computer-readable storage medium storing instructions that cause a processor to perform a method in accordance with any of clauses 1-98.

Clause 101. A non-transitory computer-readable recording medium storing a bitstream of a video which is generated by a method performed by an apparatus for video processing, wherein the method comprises: deriving a prediction sample of a video unit of the video; deriving a refined prediction sample of the video unit by applying a refinement process to the prediction sample; and generating the bitstream based on the refined prediction sample.

Clause 102. A method for storing a bitstream of a video, comprising: deriving a prediction sample of a video unit of the video; deriving a refined prediction sample of the video unit by applying a refinement process to the prediction sample; generating the bitstream based on the refined prediction sample; and storing the bitstream in a non-transitory computer-readable recording medium.

### Example Device

FIG. 18 illustrates a block diagram of a computing device 1800 in which various embodiments of the present disclosure can be implemented. The computing device 1800 may be implemented as or included in the source device 110 (or the video encoder 114 or 200) or the destination device 120 (or the video decoder 124 or 300).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement video encoding/decoding in embodiments of the present disclosure. The memory 1820 may include one or more video coding modules 1825 having one or more program instructions. These modules are accessible and executable by the processing unit 1810 to perform the functionalities of the various embodiments described herein.

In the example embodiments of performing video encoding, the input device 1850 may receive video data as an input 1870 to be encoded. The video data may be processed, for example, by the video coding module 1825, to generate an encoded bitstream. The encoded bitstream may be provided via the output device 1860 as an output 1880.

In the example embodiments of performing video decoding, the input device 1850 may receive an encoded bitstream as the input 1870. The encoded bitstream may be processed, for example, by the video coding module 1825, to generate decoded video data. The decoded video data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
deriving, for a conversion between a video unit of a video and a bitstream of the video, a prediction sample of the video unit;
deriving a refined prediction sample of the video unit by applying a refinement process to the prediction sample; and
performing the conversion based on the refined prediction sample.

2. The method of claim 1, wherein the prediction sample is derived by intra block copy (IBC).

3. The method of claim 2, wherein a function of the refinement process or at least one parameter of the function is derived based on a template of a reference block associated with the video unit, and
wherein the reference block is located by a block vector.

4. The method of claim 1, wherein the refinement process comprises a local illumination compensation (LIC), and wherein the refined prediction sample is obtained based on an IBC with the LIC.

5. The method of claim 4, wherein the method comprises:
deriving the prediction sample of the video unit by applying the IBC; and
deriving the refined prediction sample of the video unit by applying the LIC to compensate the prediction sample of the video unit.

6. The method of claim 4, wherein a linear model is used for the IBC with LIC to compensate the prediction sample of the video unit, or a non-linear model is used for the IBC with LIC to compensate the prediction sample of the video unit, and/or
wherein parameters of a model used in the IBC with LIC are derived based on coding information of the video unit.

7. The method of claim 6, wherein the linear model is represented as:
α×p[x]+β,
wherein p[x] represents the prediction sample of the video unit, and α and β represent parameters of the linear model, respectively, and/or
wherein a current template comprising neighboring reconstructed samples of the video unit and a reference template are used to derive the parameters.

8. The method of claim 7, wherein the reference template is derived using a BV that is used to obtain the prediction sample of the video unit, and/or
wherein a portion or all samples of the current template and the reference template are used to derive the parameters, and/or
wherein a least square error method is used to derive the parameters.

9. The method of claim 4, wherein the IBC with LIC is applied to at least one of: an IBC advanced motion vector prediction (AMVP) mode, or an IBC merge mode, and/or
wherein the IBC with LIC is not allowed to be applied to at least one IBC coding tool, and/or
wherein at least one syntax element is indicated to indicate whether to and/or an approach to apply the IBC with LIC for at least one of an IBC AMVP mode or an IBC merge mode, and/or
wherein whether to and/or an approach to apply the IBC with LIC for an IBC merge mode is inherited, and/or
wherein whether to and/or an approach to apply IBC with LIC depends on coding information of the video unit.

10. The method of claim 9, wherein the IBC AMVP mode comprises at least one of: a normal IBC AMVP mode, a template matching (TM) based IBC AMVP mode, a reconstruction-reordered IBC (RR-IBC) AMVP mode, a combined IBC and intra prediction (IBC-CIIP) mode, an IBC with geometry partitioning mode (IBC-GPM) mode, or other IBC AMVP mode where a BV predictor is derived and block vector difference (BVD) is indicated or derived, and/or
wherein the IBC merge mode comprises at least one of: a normal IBC merge mode, an IBC-TM merge mode, an IBC-merge mode with block vector difference (MBVD) mode, an IBC-CIIP mode, or an IBC-GPM mode, and/or
wherein the at least one IBC coding tool comprises one or more of: an RR-IBC, an IBC-CIIP, or an IBC-GPM, and/or
wherein an inheritance of whether to and/or the approach to apply the IBC with LIC is associated with a merge candidate.

11. The method of claim 10, wherein the IBC with LIC is disabled when a merge candidate belongs to a target merge type.

12. The method of claim 11, wherein the target merge type is an RR-IBC.

13. The method of claim 1, wherein the refinement process comprises a plurality of LIC models, and the plurality of LIC models is used to compensate the prediction sample of the video unit which is derived using IBC, and/or
wherein positions or a shape of a template depends on coding information of the video unit, and/or
wherein whether to and/or an approach to apply an IBC with LIC depends on at least one of: a colour format or colour components, and/or
wherein an indication of the IBC with LIC mode is indicated based on a condition, and/or
wherein whether the video unit is coded with an IBC with LIC mode is indicated using at least one syntax element.

14. The method of claim 13, wherein a plurality of LIC types comprises different LIC models with adjustment parameters for one or more existing parameters of LIC, and/or
wherein parameters of the plurality of LIC models are derived using different templates, and/or
wherein if left neighboring samples are unavailable, the template only comprises above neighboring samples, and/or
wherein if above neighboring samples are unavailable, the template only comprises left neighboring samples, and/or
wherein if left and above neighboring samples are unavailable, the IBC with LIC is not applicable, and/or
wherein the template comprises a template of a current block or a template of a reference block associated with the video unit.

15. The method of claim 14, wherein different sample lines of a template are used for deriving the parameters of the plurality of LIC models, and/or
wherein at least one of the followings is used for deriving the parameters of the plurality of LIC models: a left template, an above template, or a left-above template.

16. The method of claim 1, further comprising
determining whether the video unit is allowed to be coded with an IBC with LIC mode based on coded information of the video unit.

17. The method of claim 1, wherein the conversion includes encoding the video unit into the bitstream, and/or
wherein the conversion includes decoding the video unit from the bitstream.

18. An apparatus for video processing comprising a processor and a non-transitory memory with instructions thereon, wherein the instructions upon execution by the processor, cause the processor to:
derive, for a conversion between a video unit of a video and a bitstream of the video, a prediction sample of the video unit;
derive a refined prediction sample of the video unit by applying a refinement process to the prediction sample; and
perform the conversion based on the refined prediction sample.

19. A non-transitory computer-readable storage medium storing instructions that cause a processor to:
derive, for a conversion between a video unit of a video and a bitstream of the video, a prediction sample of the video unit;
derive a refined prediction sample of the video unit by applying a refinement process to the prediction sample; and
perform the conversion based on the refined prediction sample.

20. A non-transitory computer-readable recording medium storing a bitstream of a video which is generated by a method performed by an apparatus for video processing, wherein the method comprises:
deriving a prediction sample of a video unit of the video;
deriving a refined prediction sample of the video unit by applying a refinement process to the prediction sample; and
generating the bitstream based on the refined prediction sample.
